(19) United States
(12) Patent Application Publication
(10) Pub. No.: US 2026/0013009 A1
(43) Pub. Date: Jan. 8, 2026

(54) ON-DEMAND OHMIC LIQUID HEATER

(71) Applicant: OhmIQ, Inc., North Charleston, SC (US)

(72) Inventors: Gregory S. Lyon, Georgetown, SC (US); Pantelis J. Arvanitis, Charleston, SC (US); Brittany M. Bayley, Ladson, SC (US); Valentine B. Gruno, Summerville, SC (US)

(21) Appl. No.: 19/260,902

(22) Filed: Jul. 7, 2025

Related U.S. Application Data
(60) Provisional application No. 63/667,989, filed on Jul. 5, 2024.

(51) Int. Cl. H05B 3/26; H05B 3/03

(52) U.S. Cl. CPC H05B 3/26; H05B 3/03; H05B 2203/006; H05B 2203/021

(57) ABSTRACT

An ohmic heater for the heating of a conductive fluid is comprised of a number of selectable electrodes, arrayed in such a way as to form a single pass-through from inlet to outlet. A series of flow conduits are provided to direct the flow across the faces of adjacent electrodes. The flow conduits are further configured such that the flow path makes multiple passes across the same adjacent set of electrode faces.

### CROSS-REFERENCE TO RELATED APPLICATIONS

This application claims the benefit of the filing date of provisional U.S. Patent Application No. 63/667,989 filed on Jul. 5, 2024.

### BACKGROUND

In the arena of commercial hot beverage production, means to provide hot water for coffee, espresso, tea, etc. at point-of-sale locations such as coffee shops, cafes, etc. are well known. Water can be produced up to 100° C. in sufficient volume to produce near-continuous hot water such that beverages can be produced and sold.

In such applications, it is not unusual for the water to be heated to 95° C. for liquid beverages, and even hotter (e.g., 120° C.) for frothing steam. The supply water can be quite cool, such as around the temperature of ground water, which may be 5° C. in some cases. This temperature difference dictates that a large amount of energy, typically electrical energy, be applied to the water.

A typical approach to supplying hot water with beverage dispensing applications is to provide a tank of water of a given volume that is maintained at a target, elevated temperature, ready to dispense on command. This requires heating more water than is typically immediately necessary and then maintaining the water at the elevated temperature in the tank while awaiting the next demand. Heat is constantly lost from the external surfaces of the tank, even with the application of insulation and thermal loss abatement. The heat loss reduces the operational energy efficiency of the system.

The above approach typically utilizes an electrical resistance heating element to provide the heat. Such heaters are well-known for experiencing scaling on the heating surface of the heating element, which is associated with a reduction in efficiency and premature failure of the heating element. Electrical resistance heating elements are also known to experience dry fire failures, where the heating element fails or is damaged in situations where the heating element is heated in the absence of the target water. Hence the operational efficiency is further reduced.

Global sensitivity to energy efficiency has been heightened in recent decades to address pollution reduction, climate stability, etc. Thus, it would be propitious to provide a system where water is heated rapidly, and only when required, and also in sufficient quantities to keep up with demand. Such a system would not have the interim heat losses between dispensing operations that is inherent in a continuously heated tank system. It would further be beneficial to provide a system that includes a heating element that resists or is immune to scale build up and dry fire failures.

### SUMMARY

Aspects of the disclosure are directed to a liquid heater assembly that addresses these energy efficiency deficiencies by providing hot water, at the demanded temperature and flow rate, only when required to produce a beverage. The liquid heater assembly has no thermal losses when there is no demand, since the volume of water need not be maintained at an elevated temperature. In some aspects of the disclosure, the liquid heater assembly delivers water at the required temperature on a single pass through the heater assembly, so that there is no stagnation of water at high temperature. In still further aspects of the disclosure, the liquid heater assembly is advantageously immune to scaling and has no dry-fire failure mode, since the liquid heater does not include a high temperature electrical resistance heating element.

Some aspects of the disclosure are directed to a liquid heater assembly for heating a conductive liquid. The liquid heater assembly may include a structure defining one or more, tortuous, e.g., serpentine, spiral, etc., fluidic paths therethrough. The liquid heater assembly may further include an array of electrodes positioned along the fluidic path, with adjacent electrodes defining two of the walls of each fluidic path. The liquid heater assembly may include an inlet port and an outlet port to receive and discharge water, respectively. In at least some aspects of the disclosure, fluidic motive force is provided by line pressure from a water main.

A further aspect of the disclosure is directed to a liquid heater assembly that can provide sufficient fluidic flow to yield a determinate, coherent flow to accommodate the heating within a heating core of the liquid heater assembly. Such flow desirably has sufficient ‘wash’ so that the thermal profile across the electrodes is essentially constant.

In some aspects of the disclosure, the liquid heater assembly is an ohmic liquid heater. The liquid heater assembly in accordance with such aspects of the disclosure desirably includes a plurality of planar electrodes spaced apart along a stacking dimension, the plurality of planar electrodes including a first electrode and a second electrode adjacent to one another with a space defined between opposing planar faces of each of the first and second electrodes. The liquid heater assembly desirably also includes a structure defining fluidic path passing through the space between the first and second electrodes. In aspects of the disclosure, the structure is configured such that, when a liquid is flowing through the fluidic path in a flow direction, the liquid contacts the opposing planar faces of the first and second electrodes.

In aspects of the disclosure, the fluidic path defined by the structure desirably follows a tortuous path along a central plane disposed between the opposing planar faces of the first and second electrodes. Such path changes directions a plurality of times within the central plane so as to define a plurality of sequential portions of the fluidic path along the flow direction that pass along respective portions of the first and second electrodes. That tortuous path may define a serpentine path or a spiral path along the central plane between the first and second electrodes. Moreover, the structure defining the fluidic path may be formed of a dielectric material that electrically isolates the first electrode from the second electrode.

### BRIEF DESCRIPTION OF THE DRAWINGS

FIG. 1 is a perspective view of a liquid heater assembly in accordance with aspects of the disclosure;

FIG. 2 is a partially exploded perspective view of the liquid heater assembly of FIG. 1;

FIG. 3 is an exploded perspective view of the components of a heating core of the liquid heater assembly of FIG. 1;

FIG. 4 is an enlarged view of the indicated area of detail shown in FIG. 3;

FIG. 5 is a cross-sectional view taken along section line 5-5 of FIG. 3 illustrating a fluidic path through a portion of the liquid heater assembly of FIG. 1;

FIG. 6 is a cross-sectional view taken along section line 6-6 of FIG. 2 illustrating a portion of the fluidic path through the heating core of the liquid heating assembly;

FIG. 7A is a diagrammatic plan view of a portion of a core of a heater assembly according to another aspect of the disclosure;

FIG. 7B is a graphical representation of the velocity profile of the liquid flowing within the portion of the core illustrated in FIG. 7A;

FIG. 8 is a side perspective view of an alternate version of the liquid heater assembly in accordance with further aspects of the disclosure;

FIG. 9 is a perspective view taken from the bottom of the liquid heater assembly shown in FIG. 8;

FIG. 10 is an exploded view of the liquid heater assembly shown in FIG. 8;

FIG. 11 is an exploded view of the heating core of the liquid heater assembly shown in FIG. 10;

FIG. 12 is a cross-sectional view taken along section line 12-12 of FIG. 8;

FIG. 13 is a top view of the liquid heater assembly shown in FIG. 8;

FIG. 14 is a cross-sectional view taken along section line 14-14 of FIG. 13

FIG. 15 is a side perspective view of another alternate version of the liquid heater assembly in accordance with further aspects of the disclosure with control circuitry, power cap, and end cap removed;

FIG. 16 is an enlarged view of the indicated area of detail shown in FIG. 15;

FIG. 17 is a side perspective exploded view of the heater assembly shown in FIG. 15;

FIG. 18 is an exploded view of the electrodes and spacers of the heating core shown in FIG. 17;

FIG. 19 is a cross-sectional view taken along section line 19-19 of FIG. 17;

FIG. 20 is a cross-sectional view taken along section line 20-20 of FIG. 15;

FIG. 21 is an enlarged view of the indicated area of detail shown in FIG. 20; and

FIG. 22 is a side cross-sectional view taken along section line 22-22 of FIG. 17.

### DETAILED DESCRIPTION

Although illustrative liquid heater assemblies of this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the figures, and specific language will be used to describe the same. It will nevertheless be understood that no limitation of the scope of this disclosure is thereby intended. Any alterations and further modifications of the features illustrated herein, and any additional applications of the principles of this disclosure as illustrated herein, which would occur to one skilled in the relevant art and having possession of this disclosure, are to be considered within the scope of this disclosure.

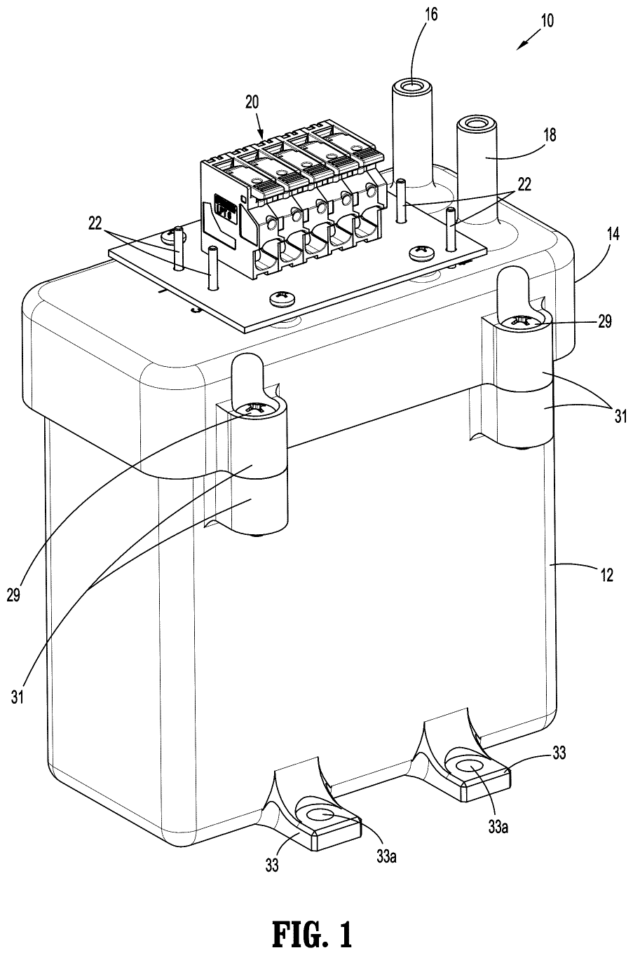

A liquid heater assembly in accordance with aspects of the disclosure is depicted in FIG. 1 as heater assembly 10. The heater assembly 10 includes a housing 12 and a power cap 14, that together enclose the internal components of the heater assembly 10. The heater assembly 10 includes an outlet port 16 from which hot water is emitted, an inlet port 18 to receive cold water, and control circuitry, e.g., a printed circuit board assembly (“PCBA”) 20, that is configured to receive and distribute electrical power and control signals to electrode contacts 22 and to the electrodes 24. In aspects of the disclosure, the outlet port 16, the inlet port 18, the PCBA 20, and the electrode contacts 22 are all positioned on the power cap 14. The electrode contacts 22 are each connected to a respective electrode 24 contained within the housing 12, as discussed in more detail below. The electrode contacts 22 are electrically connected to the PCBA 20, such as by soldering, poke-home connection, or other suitable electrical connection. In some aspects of the disclosure, the heater assembly 10 includes five electrode contacts 22 and five electrodes 24, although a heater assembly 10 having greater or fewer contacts 22 and electrodes 24 is envisioned.

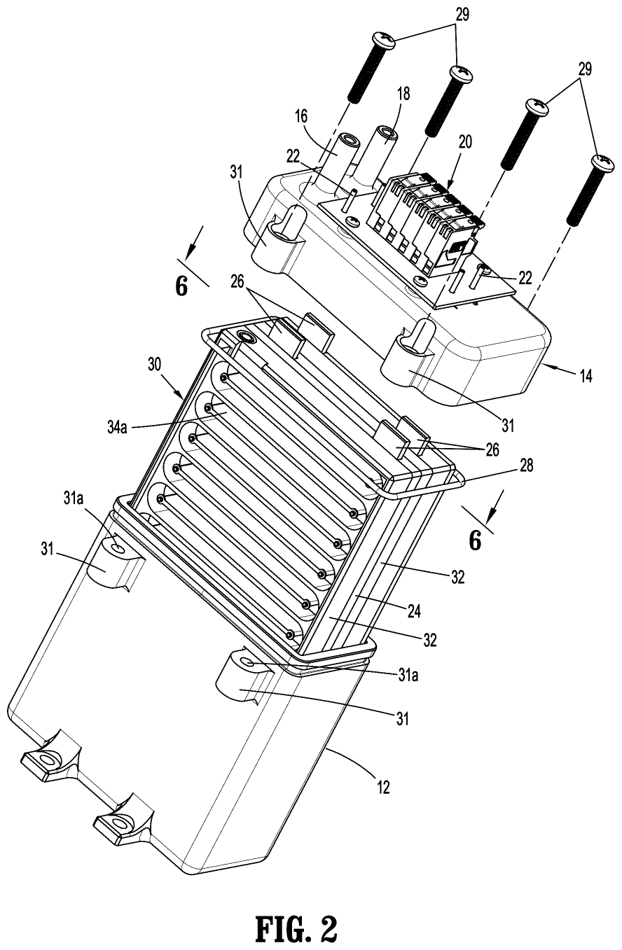

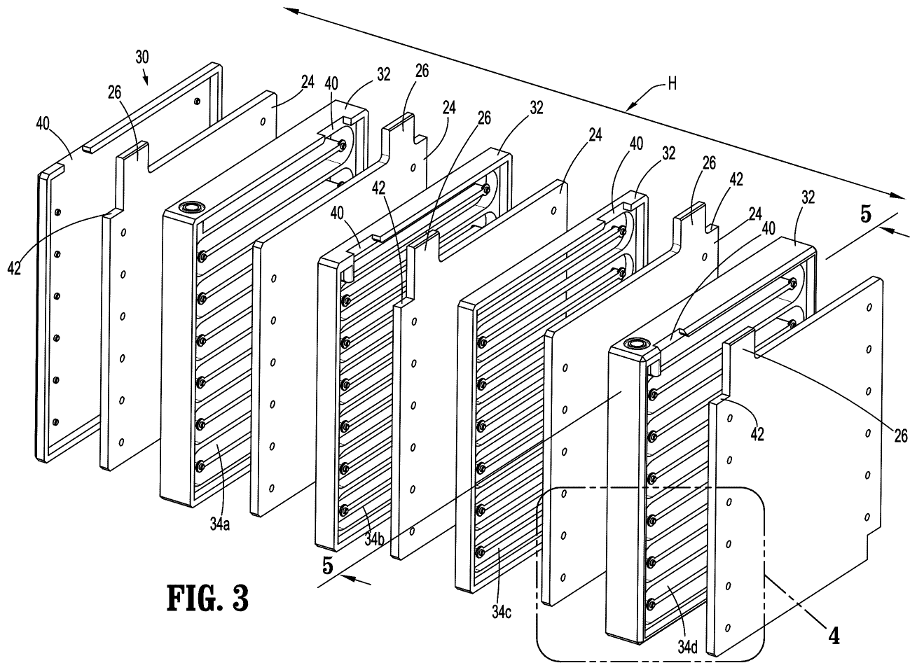

The partially exploded perspective view of the heater assembly 10 shown in FIG. 2 depicts the power cap 14 lifted from the housing 12 to expose ends of the electrodes 24. As shown, each electrode 24 includes an upwardly projecting tab 26 that extends into the power cap 14 to facilitate electrical connection of the electrodes 24 to one or more of the electrode contacts 22. An O-ring 28 is provided to seal the power cap 14 to the housing 12. A heating core 30 is contained within the housing 12 and includes an assembly of electrodes 24 and spacers 32 that define flow conduits 34a-d (FIG. 3), as will be discussed in more detail below. The first electrode 24 of the assembly of electrodes 24 is removed in FIG. 2 to show the first flow conduit 34a. In aspects of the disclosure, each of the flow conduits 34a-d is defined by a series of flow channels that define a tortuous path between two opposing faces of adjacent electrodes 24.

In aspects of the disclosure, the power cap 14 is secured to the housing 12 with bolts or screws 29. In some aspects of the disclosure, the power cap 14 and the housing 12 include flanges 31 that define threaded openings 31a that receive the bolts 29 to secure the power cap 14 to the housing 12. Alternately, it is envisioned that other securement devices can be used to secure the power cap 14 to the housing 12 including clamps or the like. The housing 12 can include flanges 33 with openings 33a to receive bolts (not shown) for securing the heater assembly 10 to a support surface.

FIG. 3 depicts an exploded view of the heating core 30 of the heater assembly 10. The heating core 30 includes an alternating stack of spacers 32 and electrodes 24. The spacers 32 are sized to space the electrodes 24 apart from each other along a stacking dimension H (FIG. 3) by predetermined distances to define the flow conduits 34a-d between opposing or confronting planar faces of adjacent electrodes 24 within each of the spacers 32. In aspects of the disclosure, the spacers 32 can have different thicknesses along the stacking dimension such that the spacing between the opposing planar faces of two adjacent electrodes 24 is different from the spacing between the opposing faces of two other adjacent electrodes 24. Thus, the width of the flow conduit 34a-d within one spacer 32 can be different from the width of the flow conduit 34a-d within another spacer 32. The different spacings between the opposing faces of electrodes 24 in the heating core 30 defined by the width of the different spacers 32 allows different combinations of electrodes 24 to be selected to yield a variety of different spacing distances between the selected electrodes 24 during operation of the heater assembly 10.

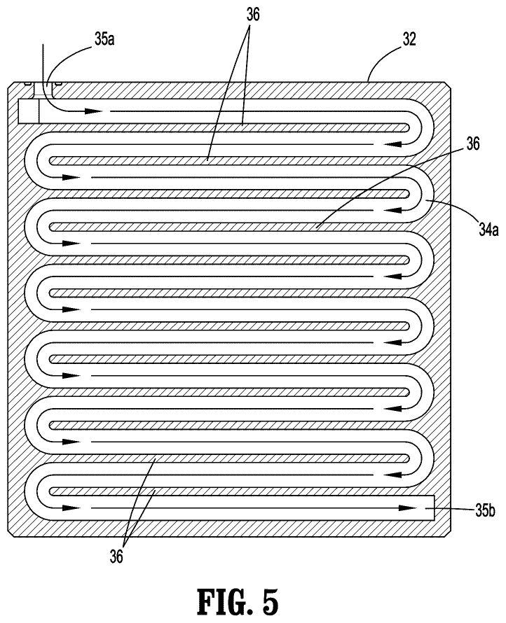

The spacers 32 may be fabricated from a dielectric material, such as a polymeric material, and may be constructed by any appropriate process, including injection molding, 3D printing, machining from a solid block of material, etc. Each of the spacers 32 includes a number of flow directing fins 36 that extend between adjacent electrodes 24 and define the configuration of the flow conduits 34a-d. The flow conduits 34a-d are open along opposing sides of each flow conduit 34a-d in the stacking dimension, such that the flow conduits 34a-d allow the liquid contained therein to contact the electrodes 24 abutting the spacer 32 on each opposing side of the flow conduit 34a-d. The engagement between the opposing faces of the electrodes 24 and the intervening spacers 32 encloses each flow conduit 34a-d so that the liquid contained within the flow conduits 34a-d is constrained to flow along the flow conduit 34a-d from an inlet 35a (FIG. 5) at one end of the flow conduit 34a to an outlet 35b at the other end of the flow conduit 34a-d. The configuration of each of the flow conduits 34a-d is discussed in more detail below.

The electrodes 24 may be generally planar components, which may have the same shape viewed along the stacking dimension as the spacers 32. The shape may be rectangular (FIG. 3), but other shapes could alternatively be used. The outer dimensions of the electrodes 24 may be at least slightly smaller than the outer dimensions of the spacers 32, such that the spacers 32 abut one another along their outer perimeters with the electrodes 24 nested within the spacers 32, as shown in FIG. 2. In aspects of the disclosure, the spacers 32 define windows 40 (FIG. 3) through their outer perimeters that are sized and shaped to allow the projecting tabs 26 of the electrodes 24 to extend therethrough, as shown in FIG. 2.

The electrodes 24 are fabricated from an electrically conductive material, such as graphite, but the material selection is not limited thereto. By selectively connecting different supply and return electrodes 24 to opposing poles of a power supply (not shown), electrical potentials may be created across different spaces between the selected supply and return electrodes 24. Specifically, the selected electrodes 24 can be connected to respective poles of the power supply by appropriate control of the PCBA 20, which creates the electrical connections via the electrode contacts 22 and projecting tabs 26. By creating those electrical potentials across the liquid contained within the flow conduits 34a-d, electrical current will flow through the liquid along the stacking dimension between electrodes 24 of opposite polarities. Due to the inherent resistance of the liquid within the flow channels defining the flow conduits 34a-d, the current flowing through the liquid will cause the liquid to heat up. Moreover, the amount of heat supplied to the liquid can be selectively controlled by varying the amount of power delivered to the liquid. For example, selecting a pair of electrodes 24 that are spaced relatively farther apart will result in relatively high resistance between those electrodes 24, and thus low power delivery. Conversely, selecting a pair of electrodes 24 that are spaced relatively closer together will result in relatively low resistance between those electrodes 24, and thus higher power delivery, assuming constant voltage. Accordingly, the power supplied to the liquid (and its corresponding temperature increase) can be controlled by dynamically selecting different groupings of electrodes 24 to connect to opposite poles of the power supply.

The control scheme for selecting the electrodes 24 to energize to control power delivery to the heater assembly 10 is not limited herein. Exemplary control schemes for dynamically selecting electrodes to energize in an ohmic liquid heater are disclosed in U.S. Pat. Nos. 7,817,906; 8,861,943, and 11,353,241, the entire disclosures of all of which are incorporated herein by reference. Any of the control schemes disclosed in any of those patents would be suitable for the control of the electrodes 24 in accordance with the disclosure.

In aspects of the disclosure, the control circuitry, e.g., the PCBA 20, is not supported on the heater assembly 1 but rather power is supplied to electrodes 24 of the heater assembly 10 via a power line or cable (not shown). In such cases, the power line or cable can be coupled to the electrical contacts 22, and ultimately to the electrodes 24, with conductors that are connected to each of the electrical contacts 22.

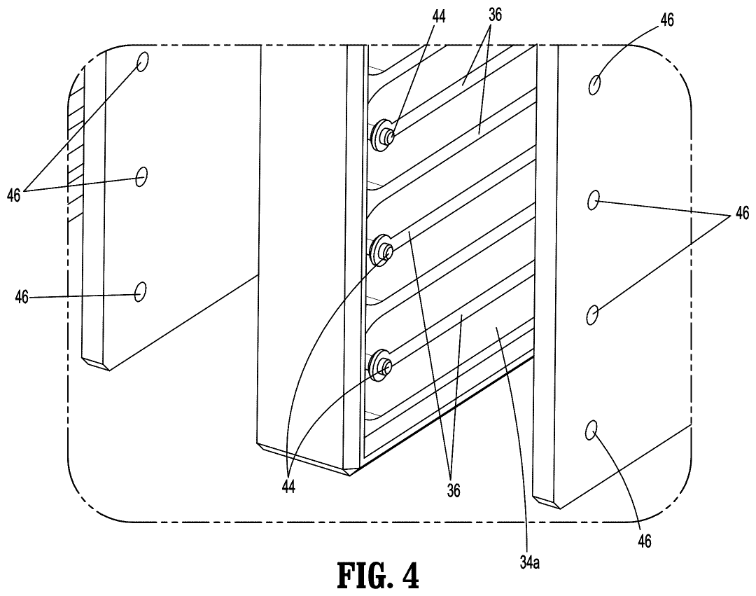

As shown in FIG. 4, in some aspects of the disclosure, the spacers 32 include a number of projecting posts 44 designed to mate with corresponding receiver holes 46 in the abutting electrodes 24. In certain aspects of the disclosure, the posts 44 secure the position of the fins 36 between the opposing planar faces of the electrodes 24 so that the hydraulic forces of the liquid will not displace the fins 24. Thus, the posts 44 may be coupled to (e.g., integrally formed with) the fins 36. In other aspects of the disclosure, the posts 44 and receiver holes 46 may be reversed, such that the posts 44 project from the electrodes 24 and are received in corresponding receiver holes 46 formed in the spacers 32, such as in the fins 36.

An exemplary water flow path through the flow conduit 34a is illustrated in FIG. 5. As shown, water is inducted into the flow conduit 34a from the inlet port 18 of the heater assembly 10 through the inlet 35a of the spacer 32 and then is directed to flow between the opposing or confronting faces of adjacent electrodes 24 by the fins 24 of the spacer 32.

In accordance with aspects of the disclosure, the flow conduits 34a-d desirably follow a tortuous path that is defined by the position of the fins 36 of the spacers 32. In aspects of the disclosure, each of the flow conduits 34a-d makes multiple passes across the opposing faces of the confronting adjacent electrodes 24 on each side of each of the flow conduits 34a-d. In some aspects of the disclosure, the path that the flow conduits 34a-d follow along the parallel planes of the confronting electrodes 24 is designed so that the liquid flowing in the flow conduits 34a-d contacts a substantial amount of the surface area of the opposing faces of the electrodes 24. In aspects of the disclosure, the amount of the surface area of the opposing faces of the electrodes 24 exposed to the flowing liquid is desirably greater than 50%. In some aspects of the disclosure, the flow conduits 34a-d may expose the liquid to more than 60% of the surface area of the opposing faces of the electrodes 24, and in further aspects of the disclosure, the flow conduits 34a-d may expose the liquid to over 70% of the surface area of the opposing faces of the electrodes 24. In some aspects of the disclosure, the flow conduits 34a-d are configured to expose the liquid therein to about 75% of the surface area of the opposing faces of the electrodes 24. In some aspects of the disclosure, each of the flow conduits 34a-d makes a ‘serpentine’ path across the opposing faces of the electrodes 24, starting from the top of the heater assembly 10, and then traversing repeatedly back and forth, ultimately to the outlet port 35b at the lower right of the respective flow conduit 34a-d, where the water then flows into the next flow conduit 34b-d along the stacking dimension. To allow flow from flow conduit 34a into flow conduit 34b, the intervening electrode 24 may include a passageway 42 through it, such as by a cutout through a corner of the electrode 24 as shown in FIG. 3.

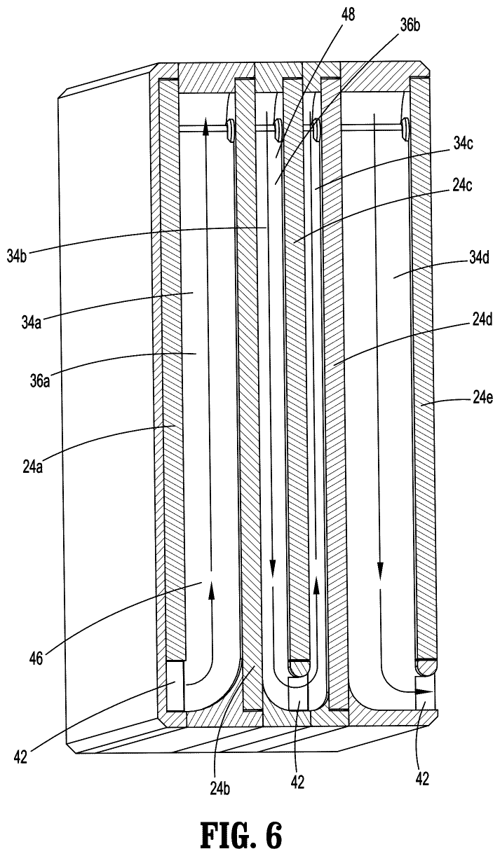

FIG. 6 illustrates the flow path along the stacking dimension from flow conduit 34a to flow conduit 34d. Specifically, after passing from inlet port 18 (FIG. 1) of the power cap 14 into the core 30, the flow first passes into the flow channel 46 in the first flow conduit 34a between a first electrode 24a and a second electrode 24b. In the view in FIG. 6, the flow passes along the top of the first fin 36a in the first flow conduit 34a before passing downwardly (into the page) along a serpentine path defined by the first flow conduit 34a. When reaching the bottom of the first flow conduit 34a, the flow moves through a passageway 42 (not shown) in the second electrode 24b and then into the second flow conduit 34b before following its serpentine path upwards into the flow channel 48 of the second flow conduit 34b. The flow path then passes along the top of the uppermost fin 36b along the flow channel 48 in the second flow conduit 10B before passing through a passageway 42 in the third electrode 24c. That same progression then repeats through the third flow conduit 34c, and the fourth flow conduit 34d, which is bounded on its outer end by the fifth electrode 24c.

The flowrates encountered in the production of hot beverages are typically small, on the order of 2-15 ml/s. At the same time, a certain ‘washing’ action is important to avoid flow stagnation. Such stagnation within the electric field could lead to local overheating of the water. Since the conductivity of water increases with temperature, the stagnant volumes will locally draw more current, thus creating positive feedback that makes the design and control of the heater indeterminate and unpredictable.

Stagnation results from the viscous forces of the fluid overcoming the velocity forces of the fluid. The Reynolds number is the non-dimensional number that represents the ratio of dynamic forces to viscous forces, and it is also the predictor of laminar vs turbulent flow. Low Reynolds numbers indicate laminar flow, whereas high Reynolds numbers indicate turbulent flow. To avoid stagnation, a Reynolds number of approximately 104, i.e., turbulent flow, is desired.

Particularly at the relatively low flow rates that are the regime of beverage dispensing apparatuses such as coffee makers, it may be difficult to achieve uniform, coherent flow through the heating core 30. Therefore, in accordance with aspects of the disclosure, the flow channels defining the flow conduits 34a-d within the heating core 30 are designed to achieve a high Reynolds number. For example, the tortuous (e.g., serpentine) path is desirably designed with a relatively small cross section, so as to affect a high Reynolds number, while still exposing the water to the majority of the area of the electrode faces. By contrast, if the flow path were simply a planar path, with no serpentine attempted, the resulting flow would be erratic, uncontrollable, and subject to low velocity and stagnation.

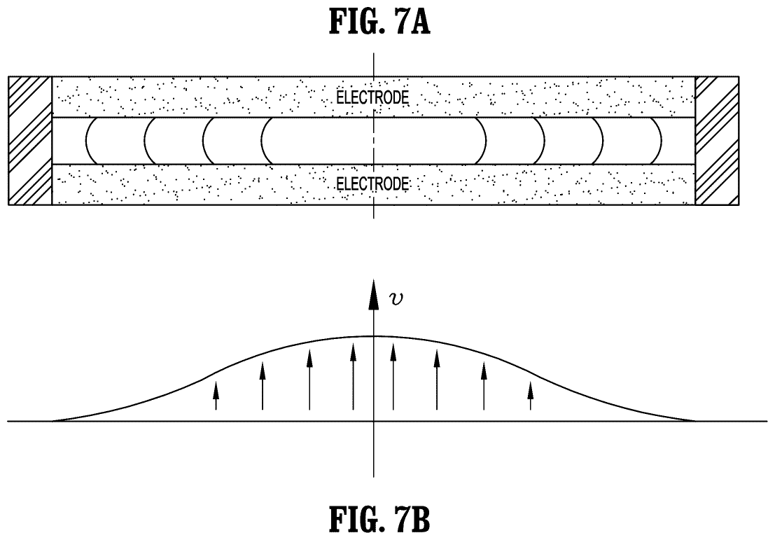

One example of such a flow path is shown in FIG. 7A, in which the flow path extends across the planes of the confronting faces of the electrodes in a single pass (i.e., with no serpentine or tortuous path followed along those planes). This results in an exaggerated aspect ratio of the resulting flow channel, in which the width is much larger than the height. As shown diagramatically in FIG. 7B, that produces a velocity profile across the planar faces of the electrodes 24 in which the velocity is highest in the center along the width dimension but decreases down to almost zero towards the outer edges in the width dimension. This results in significant stagnation towards those outer edges of the flow path, which, as discussed above, can create local overheating problems in the ohmic heating context.

One ideal cross section of the flow channels forming the flow conduits 34a-d, e.g., flow channels 46 and 48 of flow conduits 34a and 34b, is a substantially square aspect ratio, i.e., where the width in the stacking dimension is approximately equal to the height, as that will maximize the effective hydraulic diameter, thus driving the Reynolds number up. In some aspects of the disclosure, the aspect ratio can be between about 1 and about 5. As illustrated in FIG. 3, the heights of the flow channels in each of the flow conduits 34a-d are all the same. This may improve manufacturing, as the assembly posts 44 and holes 46 can be shared across different layers of the heating core 30 in the stacking dimension. As a result, since the thicknesses of the flow conduits 34a-d vary in the stacking dimension, as discussed above, the widths of the flow channels of each of the flow conduits 34a-d will vary at least slightly from flow conduit 34a to flow conduit 34b. In alternative aspects of the disclosure (not shown), the heights of the flow channels defining the flow conduits 34a-d may also vary from flow conduit 34a to flow conduit 34d in order to achieve an approximately square aspect ratio in each flow conduit 34a-d.

Consistent with aspects of the disclosure, other modifications may be made to the flow channels that define the flow conduits 34a-d to reduce stagnation. For example, the cross-sectional shape of the flow channel perpendicular to the flow direction may be varied from a quadrilateral shape in order to improve flow, particularly in the corners of the cross-section. As an example, at least some of the sides of the flow channels in that cross section may be curved, such as by having the surfaces of the fins 36 bordering the flow channels define an arcuate profile along stacking dimension and/or by creating curved profiles in the electrodes 24 along the portions confronting the flow channels.

Another aspect of the disclosure is the use of polarity switching, in which each electrode can exist in three states versus the traditional two states. That is, in prior Ohmic heating devices, each electrode generally exists in one of two states: on or off. For one electrode, the states might be off or L1. For the adjacent electrode, the states would be off or L2, where L1 and L2 are opposite polarities supplied by the power supply. By adding additional switches to the controls, aspects of the disclosure allow the first electrode to be powered to L1, off, or L2. The additional state provides a much greater number of electronic states, thus increasing the power resolution and allowing for a net reduction in electrode count.

An exemplary method of operation of the heater assembly 10 in accordance with aspects of the disclosure will now be briefly summarized. Initially, when hot water is demanded, the outermost electrodes are energized to determine the effective conductivity, while simultaneously measuring incoming water temperature. The flow rate is known, usually fixed by the upstream and downstream hydraulic features of the delivery path. The temperature setpoint is pre-defined by the user. The effective conductivity is calculated as the conductivity at the average of the inlet temperature and the setpoint temperature. A strategy, or the electrode array that is energized, can be determined so as to affect the setpoint temperature at steady state. That is, such strategy is determined so that, after a single pass of water through the heater assembly 10, the outlet flow will be at, or close to, the setpoint temperature. Minor adjustments to the strategy can then be made. It is envisioned that the conductivity of water within the heater can be measured using a variety of different devices and techniques.

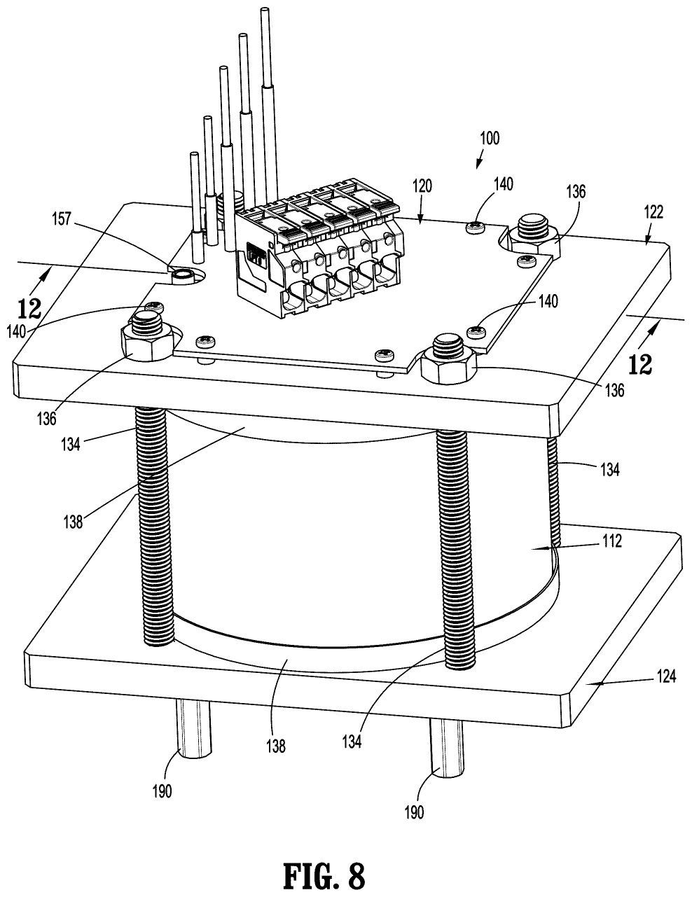

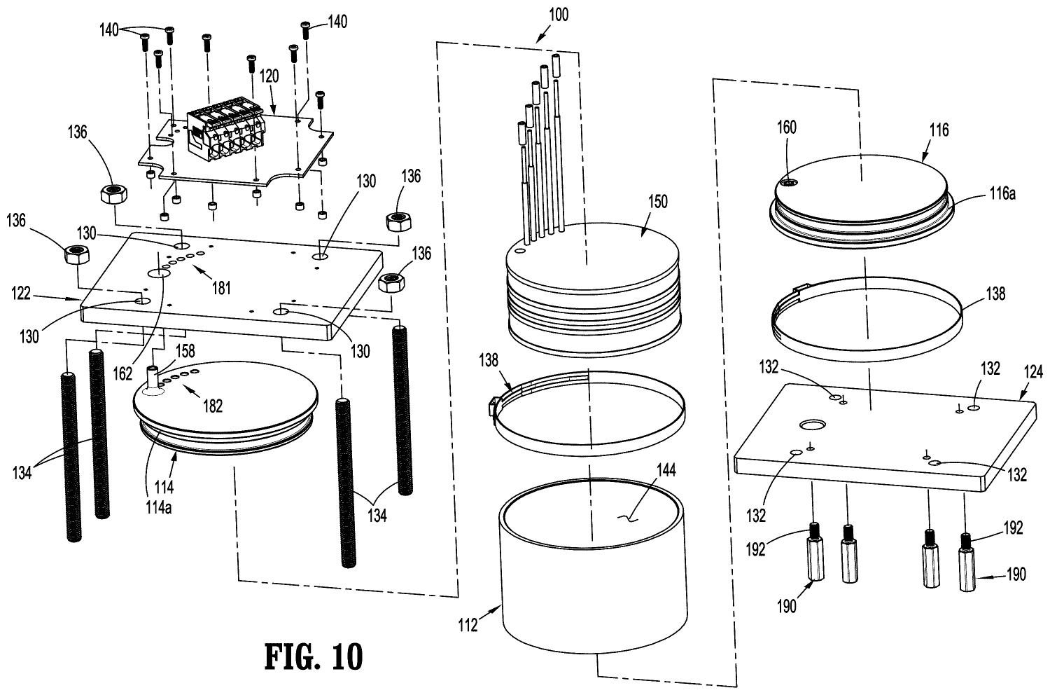

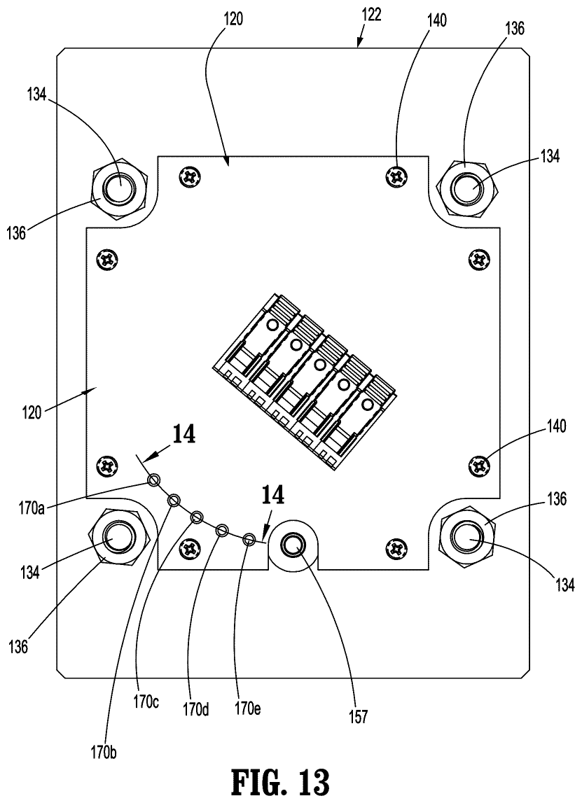

FIGS. 8-14 illustrate an alternate version of the liquid heater assembly shown generally as heater assembly 100. The heater assembly 100 includes a housing 112, a power cap 114 (FIG. 10), an end cap 116 (FIG. 10), a PCBA 120, a first support plate 122, and a second support plate 124. In aspects of the disclosure, the housing 112, the power cap 114, and the end cap 116 have cylindrical configurations. In some aspects of the disclosure, the power cap 114 and the end cap 116 have stepped cylindrical configurations that define shoulders 114a and 116a. When assembled, the smaller diameter portions of the power cap 114 and the end cap 116 are received within the housing 112 and the shoulders 114a and 116a engage respective ends of the housing 112.

The first support plate 122 is positioned on the power cap 114 and the second support plate 124 is positioned on the end cap 116. In aspects of the disclosure, the first and second support plates 122 and 124 define openings 130 and 132 (FIG. 10), respectively, that receive threaded bolts 134 that secure the first and second support plates 122 and 124 to each other and secure the power cap 114 and the end cap 116 to the housing 112. The openings 130 and 132 can be threaded openings or through bores. In some aspects of the disclosure, the openings 132 are threaded openings that engage the bolts 134, and the openings 130 allow passage of the bolts 134 for engagement with nuts 136. Alternately, other securement devices and techniques are envisioned.

In some aspects of the disclosure, the heater assembly 100 includes reinforcing bands 138 (FIG. 10) that are secured in tension about the first and second ends of the housing 112 adjacent to the first and second support plates 122 and 124, respectively. The reinforcing bands 138 are provided to avoid fiber splay when the housing 112 is formed from a composite tube, e.g., wound fibers.

The PCBA 120 is secured to the outer surface of the first support plate 122. In aspects of the disclosures, the PCBA 120 is secured to the first support plate 122 with screws 140 although the use of other securing devices or techniques is envisioned.

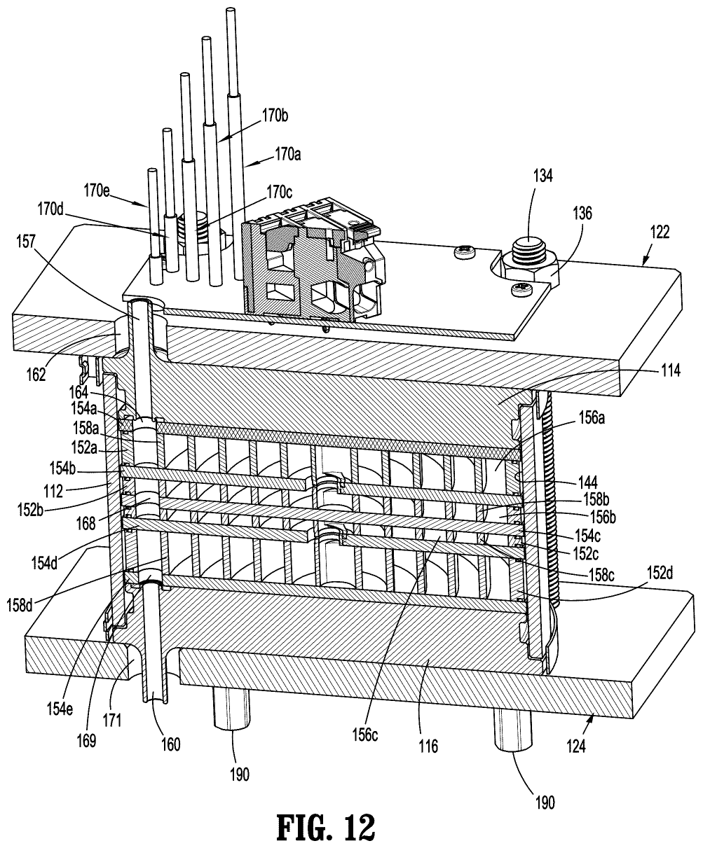

The housing 112 defines a cylindrical cavity 144 (FIG. 12) that receives a heating core 150 (FIG. 10) that includes an alternating stack of spacers 152a-d and electrodes 154a-c. Each of the spacers 152a-d forms a flow conduit 156a-d that is defined by a fin 158a-d of the spacer 152a-d and confronting faces of two adjacent electrodes 154a-c. In aspects of the disclosure, the fins 158 are positioned between opposing faces of adjacent electrodes 154a-c and have a spiral configuration. Alternately, other tortuous configurations are envisioned. In aspects of the disclosure, each of the electrodes 154a-e includes two planar faces.

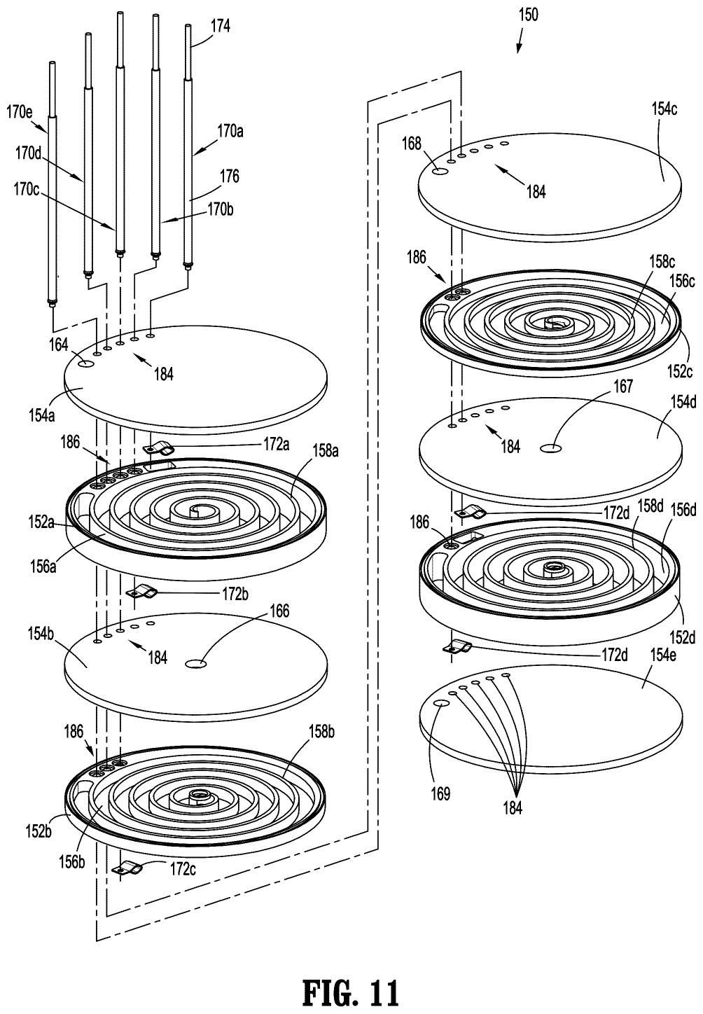

As illustrated in FIGS. 11 and 12, the flow conduits 154a-d communicate with each other and with an inlet port 157 and an outlet port 160 (FIG. 12) to define a fluidic circuit through the heater assembly 100. In aspects of the disclosure, the fluidic circuit has a predefined configuration. In aspects of the disclosure, the power cap 114 supports or includes the inlet port 157 which extends through an opening 162 (FIG. 10) in the first support plate 122 and is adapted to be connected to a cold-water source, e.g., a water main. The inlet port 157 (FIG. 12) defines a channel 157a that extends through the power cap 114 and communicates with an opening 164 in the electrode 154a. The opening 164 in the electrode 154a communicates with the flow conduit 156a defined between the electrodes 154a and 154b and the fin 158a near an outer periphery of the heater assembly 100. The water flows over confronting planar surfaces of the electrodes 154a and 154b through the flow conduit 156a along the spiral flow path to the center of the spacer 152a and exits through the center of the flow conduit 156a through a central opening 166 (FIG. 11) defined in the electrode 154b. The water travels from the opening 166 in the electrode 154b into a center of the flow conduit 156b (FIG. 12) defined by the fin 158b and the confronting faces of the electrodes 154b and 154c. The water flows through the flow conduit 156b from the center of the spacer 152b to the outer periphery of the spacer 152b, where the water flows through an opening 168 in the electrode 154c into the outer periphery of the flow conduit 156c defined by the fin 158c and the confronting faces of the electrodes 154c and 154d. Once again, the water flows from the outer periphery of the flow conduit 156c to the center of the flow conduit 156c and passes through an opening 167 in the electrode 154d into the center of the flow conduit 156d defined by the fin 158d and the confronting faces of the electrodes 154d and 154c. The water again flows from the center of the flow conduit 156d towards the outer periphery of the flow conduit 156d through an opening 169 formed in the electrode 154c and exits the heater assembly 100 through the outlet port 160 (FIG. 12). In aspects of the disclosure, the outlet port 160 forms part of the end cap 116 and extends through an opening 171 formed in the second support plate 124.

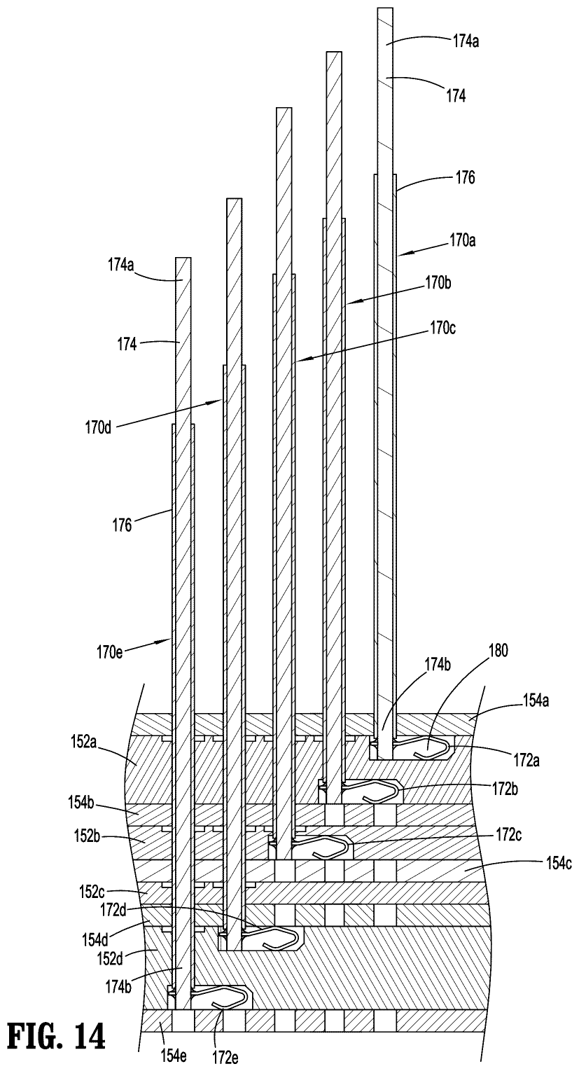

The PCBA 120 is supported on the first support plate 122 and is configured to receive and distribute electrical power and control signals to the electrodes 154a-e via conductors 170a-e and electrode contacts 172a-c. The conductors 170a-e are coupled to the PCBA 120 and to the electrode contacts 172a-e (FIG. 14), and the electrode contacts 172a-c are coupled to the electrodes 154a-c. In aspects of the disclosure, the heater assembly 100 includes five conductors 170a-e, five electrode contacts 172a-e, and five electrodes 154a-c, although a heater assembly having greater or fewer conductors, contacts, and electrodes is envisioned.

In aspects of the disclosure, each of the conductors 170a-e includes a conductive rod 174 (FIG. 14) that is encased in a dielectric sleeve 176 with the ends of the conductive rod 174 protruding from the dielectric sleeve 176. One end 174a of each of the conductive rods 174 is electrically coupled to the PCBA 120 and the other end 174b of each of the conductive rods 174 is electrically coupled to one of the electrodes 154a-c. In some aspects of the disclosure, each of the ends 174b of the conductive rods 174 of each of the conductors 170a-c is electrically coupled to one of the electrode contacts 172a-e such as by soldering, poke-home connection, or other suitable electrical connection, and each of the electrode contacts 172a-e is received within a pocket 180 (FIG. 14) defined within the a respective spacer 152a-d such that the electrode contacts 172a-e are compressed between a respective one of the spacers 152a-d and one of the electrodes 154a-e. Alternately, the use of other electrical connection devices or connections is envisioned. The spacers 152a-d are formed of a dielectric material.

In some aspects of the disclosure, each of the conductors 170a-e extends through openings 181 (FIG. 10) defined in the first support plate, openings 182 (FIG. 10) defined in the power cap 114, openings 184 (FIG. 11) defined in the electrodes 154a-c, and openings 186 (FIG. 11) defined in the spacers 152a-d to facilitate electrical communication between the PCBA 120 and the electrodes 154a-e. Although each of the electrodes 154a-e is shown to define five openings 184, it is noted that only four openings 184 need be provided in the electrode 154b, three openings 184 in electrode 154c, two openings in electrode 154d, and one opening 184 in electrode 154e to facilitate communication between the PCBA 120 and the electrodes 154a-c. The provision of five openings 184 in each of the electrodes 154a-e simplifies the manufacturing and assembly process by allowing each of the electrodes 154a-e to be formed identically. It is noted that the openings 184 in the electrodes 154a-e that are not required to facilitate passage of a conductor 170a-e are sealed by the spacers 152a-d.

As described above regarding the spacers 32, the width of the spacers 152a-d can be different from each other to provide different spacings between the opposing faces of each of the adjacent electrodes 154a-e. Thus, the amount of heat supplied to the liquid can be selectively controlled by varying the amount of power delivered to the liquid by selecting pairs of electrodes 154a-e having different spacings.

As also described above regarding the flow channels that define the flow conduits 34a-34d (FIG. 3), the amount of the surface area of the opposing faces of the electrodes 154a-e exposed to the flowing liquid is desirably greater than 50%. In some aspects of the disclosure, the flow conduits 156a-d may expose the liquid to more than 60% of the surface area of the opposing faces of the electrodes 154a-e, and in further aspects of the disclosure, the flow conduits 156a-d may expose the liquid to over 70% of the surface area of the opposing faces of the electrodes 154a-c. In still other aspects of the disclosure, the flow conduits 156a-d are configured to expose the liquid therein to about 75% of the surface area of the opposing faces of the electrodes 154a-c. In some aspects of the disclosure, the flow conduits 156a-d within the heating core 150 are designed to achieve a high Reynolds number. For example, the tortuous (e.g., spiral) path is desirably designed with a relatively small cross section, so as to affect a high Reynolds number, while still exposing the water to the majority of the area of the opposing faces of the electrodes 154a-c.

Ideally, the cross section of the flow conduits 156a-d has an aspect ratio that is about 1, i.e., the width in the stacking dimension of the flow conduits 156a-d is approximately equal to the height, as that will maximize the effective hydraulic diameter, thus increasing the Reynolds number. In aspects of the disclosure, the heights of the flow channels 156a-d can be all the same to simplify manufacturing, but the thicknesses of the flow conduits 156a-d can vary in the stacking dimension to vary the spacing between the opposing faces of the adjacent electrodes 154a-c. In alternative aspects of the disclosure (not shown), the heights of the flow conduits 156a-d may also vary from one flow conduit 156a-d to the other flow conduits 156a-d in order to achieve an approximately square aspect ratio in each of the flow conduits 156a-d.

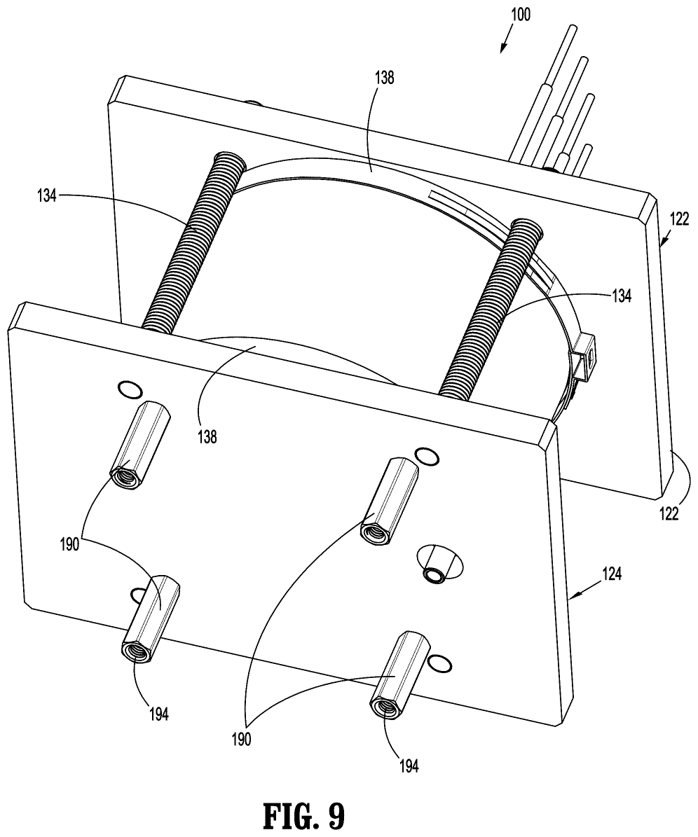

In some aspects of the disclosure, the heater assembly 100 includes mounting standoffs 190 (FIG. 9) that are secured to an outer surface of the second support plate 124 to facilitate mounting of the heater assembly 100 to a support surface. In certain aspects of the disclosure, each of the mounting standoffs 190 includes a first end having outer threads 192 (FIG. 10) and a second end defining a threaded bore 194 (FIG. 9). The first ends of the mounting standoffs 190 are secured to the second support plate 124 and the threaded bores 194 can receive screws to secure the heater assembly 100 to the support surface (not shown). Alternately, other types of mounting devices are envisioned to mount the heater assembly 100 to a support surface.

As described above, the PCBA 20, 120 is configured to receive electrical power and control signals and to distribute power to the electrodes. In aspects of the disclosure, rather than receiving control signals, the PCBA can include components that provide control functionality to provide power to the electrodes to operate the heater. This PCBA may include various electrical components, such as power management circuitry, sensing circuitry, relay or switching circuitry, one more controller(s), one or more memory, and/or communication circuitry, among other possible components.

In some aspects of the disclosure, the PCBA 20, 120 may include power management circuitry which manages voltage and/or current, such as AC/DC converters, step-up converters, step-down converters, and/or waveform shaping circuitry (e.g., pulse width modulation circuitry), among other possibilities.

In further aspects of the disclosure, the PCBA 20, 120 may include sensing circuitry such as voltage sensors, current sensors, and/or circuitry that interfaces with sensors in the heater, such as circuitry that interfaces with temperature sensors in the heater, for example. The sensing circuitry may include, for example, amplifiers and/or analog-to-digital converters, among other possibilities.

In aspects of the disclosure, the PCBA 20, 120 may include relay or switching circuitry such as switches that connect and disconnect power to various of the electrodes. In some aspects of the disclosure, the relay or switching circuitry may include switches that connect to different electrical potentials from a power source. The relay or switching circuitry may include solid-state switches, among other possibilities.

In aspects of the disclosure, the PCBA 20, 120 may include one or more controller(s), which may include any type of device that can provide control and/or computing functionality, such as microcontrollers, microprocessors, central processing units, and/or digital signal processors, among other possibilities. In aspects of the disclosure, the controller(s) may include and may execute firmware instructions. In aspects of the disclosure, the controller(s) may execute machine-readable instructions accessed from the one or more memories, which may include volatile memory (e.g., random access memory, etc.) and/or non-volatile memory (e.g., EEPROM, etc.). The machine-readable instructions may implement control functionality, such as controlling operations of the heater. In aspects of the disclosure, the control functionality may connect power to various of the electrodes at various times according to a predetermined operation. In aspects of the disclosure, the control functionality may process sensing signals provided by the sensing circuitry to perform various computations and may connect power to various of the electrodes based on the computations. For example, the one or more controller(s) may operate to direct power to various of the electrodes in different cycles. As another example, the controller(s) may receive an input reflective of a set point temperature and receive sensing signals reflective of measured temperatures in the heater. The controller may direct or not direct power to various of the electrodes based on the set point temperature and the sensing signals reflective of the measured temperatures. Various other operations are described below herein. All such operations are contemplated to be within the scope of the present disclosure.

In aspects of the disclosure, the PCBA 20, 120 may include communication circuitry, such as wireless communication circuitry enabling communication using technologies such as Wi-Fi, Bluetooth, and/or cellular communications, among other wireless communication technologies. In aspects of the disclosure, the communication circuitry may communicate with a user device, such as a smartphone, tablet, or other user device. In aspects of the disclosure, the communication circuitry may transmit information to and/or receive information from a cloud system. The information communicated by the communication circuitry may be used in various ways, such as used by a user app to control operation of the heater and/or to view performance of the heater, or use to update firmware within the heater, among other possibilities. Such and other aspects of the disclosure are contemplated to be within the scope of the disclosure.

In aspects of the disclosure, the control circuitry, e.g., the PCBA 120, is not supported on the heater assembly 100 but rather power is supplied to the electrodes 154a-e of the heater assembly 100 via a power line or cable (not shown). In such cases, the power line or cable can be coupled to the electrical contacts 172a-e, and ultimately to the electrodes 154a-c, with conductors that are connected to each of the electrical contacts 172a-c.

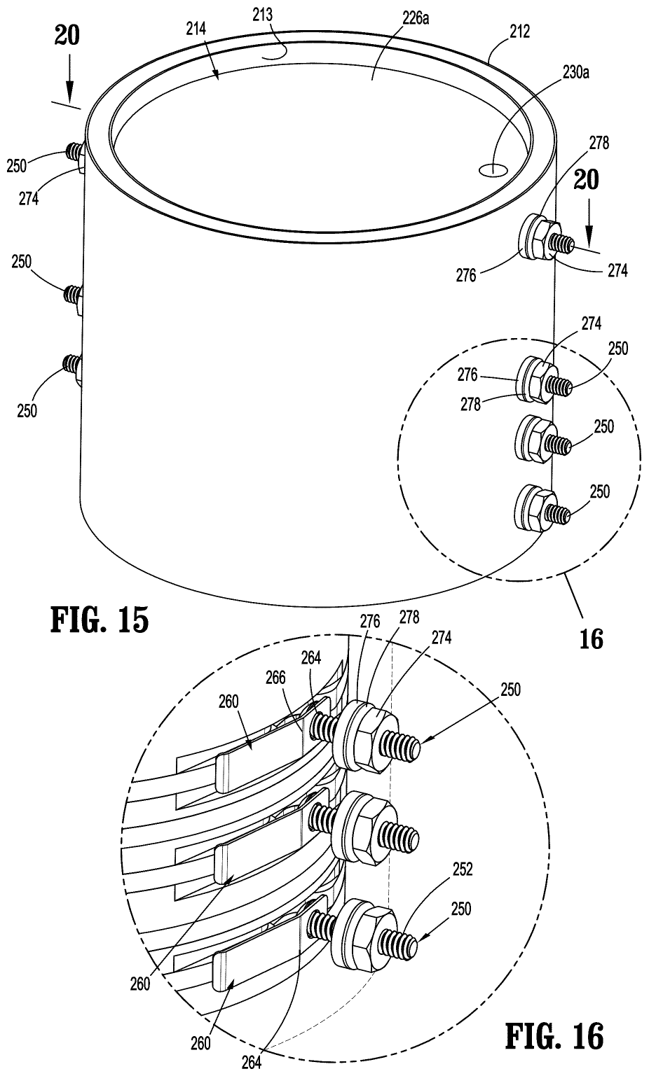

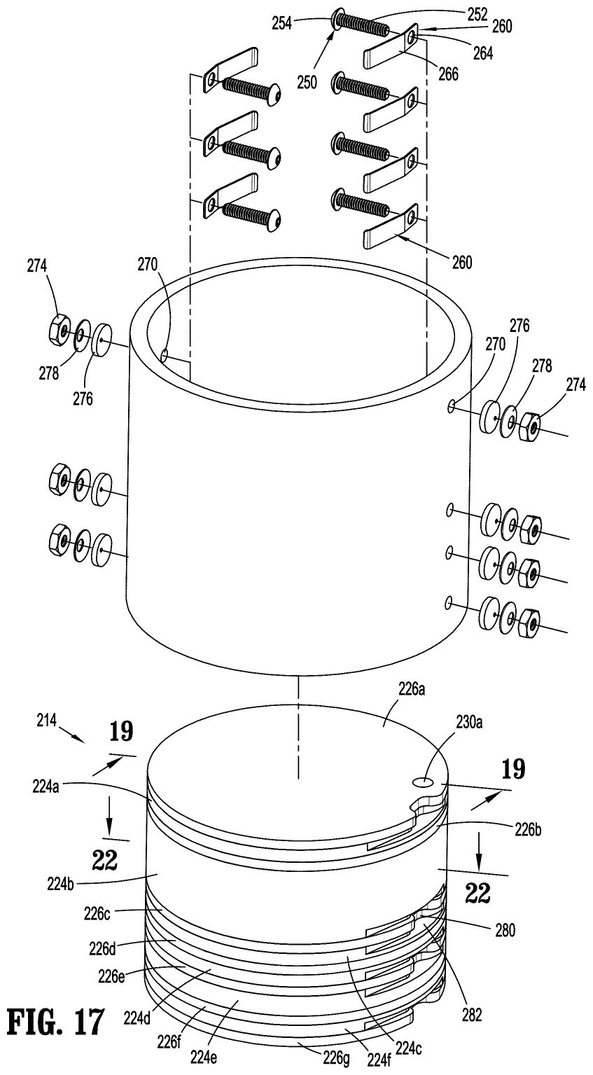

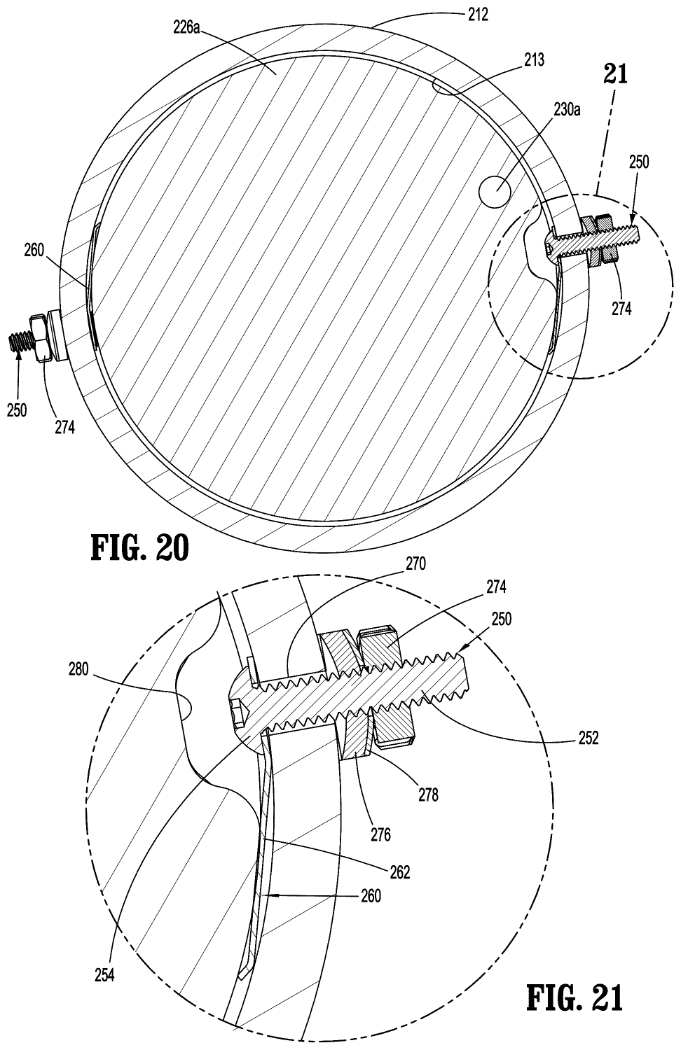

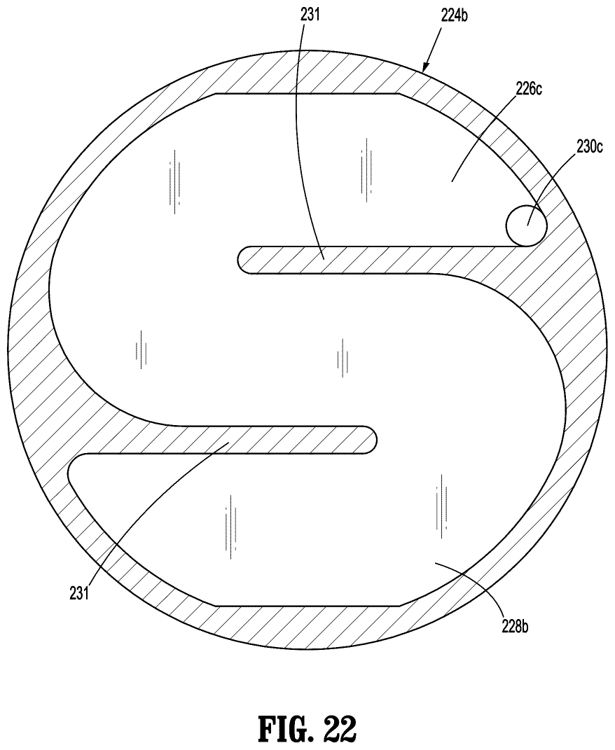

FIGS. 15-22 illustrate another alternate version of the liquid heater assembly shown generally without the control circuitry, the power cap, or the end cap as heater assembly 200. The heater assembly 200 includes a housing 212 that defines a cavity 213 and a heating core 214 that is received within the cavity 213. In aspects of the disclosure, the housing 212 and the cavity 213 have cylindrical configurations although other configurations are envisioned. The heating core 214 includes an alternating stack of spacers 224a-f and electrodes 226a-g. Each of the spacers 224a-f forms a flow conduit 228a-f that is defined by fins 231 of the spacers 224a-d and confronting planar faces of two adjacent electrodes 226a-g. In aspects of the disclosure, the fins 231 are positioned between opposing faces of adjacent electrodes 226a-g and have a tortuous configuration, e.g., S-shaped. Alternately, other tortuous configurations are envisioned. In aspects of the disclosure, each of the electrodes 226a-g includes two planar faces that engage the fins 231 of two adjacent spacers 224a-f to seal opposite sides of each of the flow conduits 228a-f.

As described above regarding the spacers 32 and 152a-d, the width of the spacers 224a-d can be different from each other to provide different spacings between the opposing planar faces of each of the adjacent electrodes 226a-g. Thus, the amount of heat supplied to the liquid can be selectively controlled by varying the amount of power delivered to the liquid by selecting pairs of electrodes 226a-g having different spacings.

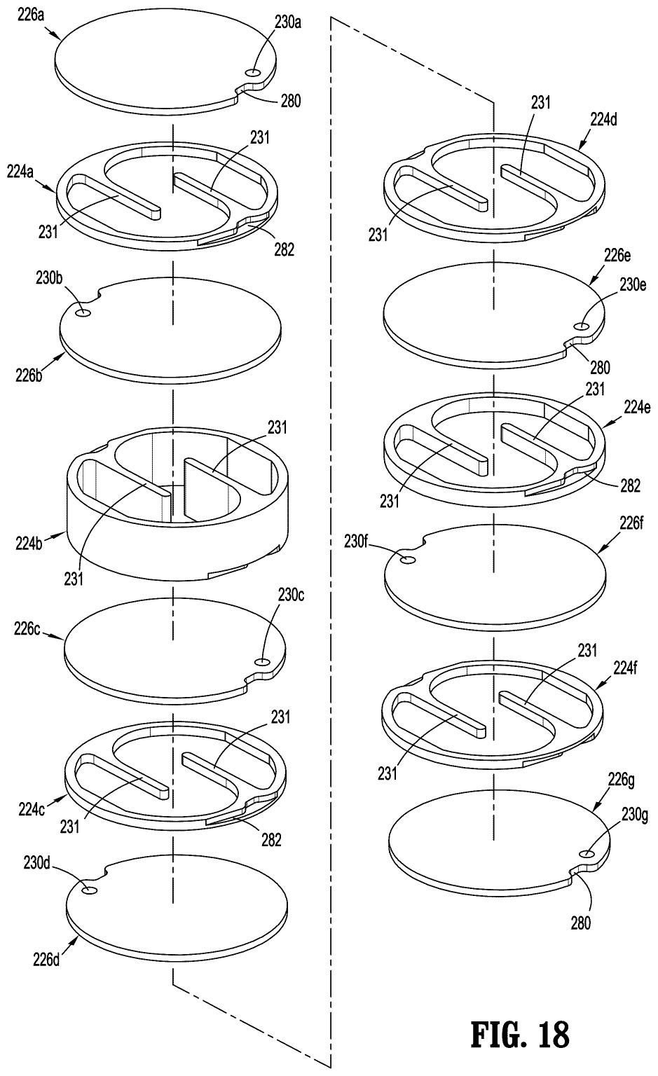

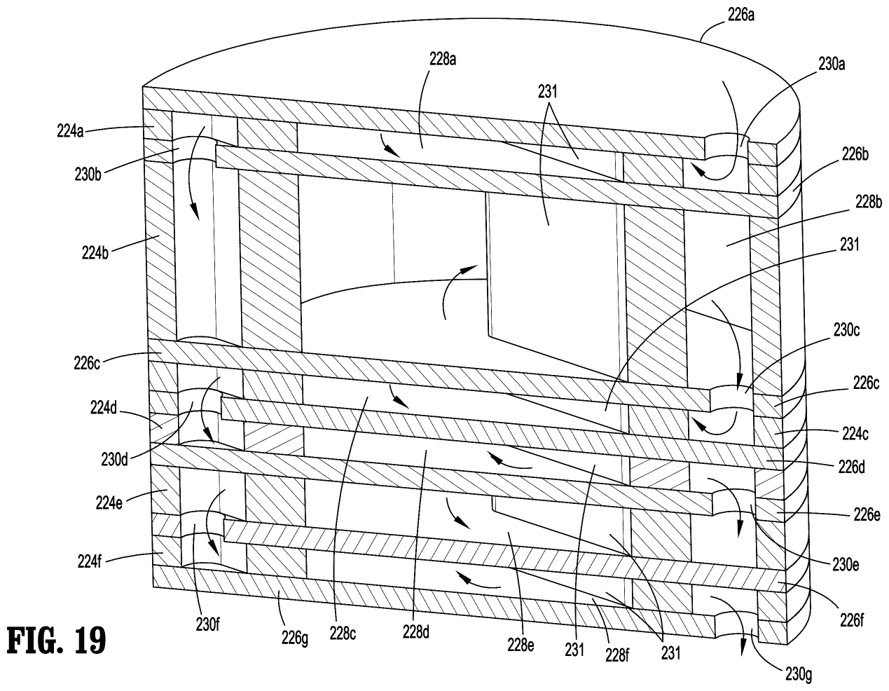

In aspects of the disclosure, the heating core 214 includes seven electrodes 226a-g and six spacers 224a-f, although it is envisioned that the heating core 214 can include two or more electrodes 226a-b and one or more spacers 224a positioned in alternating stacked relation to each other. In some aspects of the disclosure, each of the electrodes 226a-g defines an opening 230a-g (FIG. 18) to facilitate fluid flow through the electrode 226a-g and into one of the flow conduits 228a-f. In aspects of the disclosure, water is delivered from an inlet port (not shown) through the opening 230a (FIG. 19) of the electrode 226a into the flow conduit 228a. The water passes through the flow conduit 228a in the direction of arrows “S” defined by the fins 231 and flows into the opening 230b defined by the electrode 226b into the flow conduit 228b. The water continues to flow through the heating core 214 until the water passes into the flow conduit 228f. The water then flows though the flow conduit 228f and exits the heating core 214 through the opening 230g in electrode 226g through an outlet port (not shown) of the heater assembly 200.

The heater assembly 200 includes conductors 250 and electrical contacts 260 to electrically couple the power supply to the electrodes 226a-g. In some aspects of the disclosure, each of the conductors 250 is in the form of a bolt (FIG. 21) having a threaded shaft 252 and a head 254, and each of the electrical contacts 260 is in the form of a conductive plate 262. The conductive plate 262 defines an opening 264 and includes a bend 266. Each of the threaded shafts 252 of the conductors 250 is received through the opening 264 of a respective one of the electrical contacts 260 and through an opening 270 formed in the housing 212. The head 254 of the conductor 250 is larger than the opening 264 in the electrical contact 260 such that the head 254 of the conductor 250 secures or clamps one end of the electrical contact 260 to the inner surface of the housing 212. In aspects of the disclosure, the threaded shaft 252 of each of the conductors 250 receives a nut 274 and a pair of washers 276, 278 to secure each conductor 250 and the electrical contact 260 to the housing 212. In aspects of the disclosure, the pair of washers 276, 278 are formed as a single component. The bend 266 of each of the electrical contacts 260 is angled towards a respective electrode 226a-g to maintain engagement between the electrical contacts 260. In certain aspects of the disclosure, the electrical contacts 260 are formed of a spring-like conductive material, e.g., spring steel, titanium and titanium alloys, beryllium copper, etc., that are elastically deformed when engaged with the electrodes 226a-g to maintain contact between the electrical contacts 260 and the electrodes 226a-g.

In some aspects of the disclosure, each of the electrodes 226a-g includes a cutout 280 that is positioned adjacent to the head 254 of a respective conductor 250 to space each of the conductors 250 from a respective electrode 226a-g. In further aspects of the disclosure, each of the spacers 224a-f defines a recess 282 positioned adjacent to a respective conductor 250 and a respective electrical contact 260 to allow unobstructed engagement of the electrical contacts 260 with the electrodes 226a-g.

Although not shown, the heater assembly 200 includes or is coupled to control circuitry to deliver power to selected electrodes to achieve the advantages described above regarding heater assemblies 10 and 100. The flow conduits 228a-g of the heating core 214 are also configured to result in a Reynolds number and aspect ratio to produce turbulent flow as described above regarding flow conduits 34a-d and 156a-d.

Further aspects of the disclosure are provided by the subject matter of the following clauses:

A liquid heater assembly comprising: a housing defining a cavity, the housing having an inlet port and an outlet port; a heating core received within the cavity and including a first electrode, a second electrode, and a first spacer formed of a dielectric material positioned between the first electrode and the second electrode, each of first electrode and the second electrode having planar faces, the first spacer positioned between and engaged with the planar faces of the first electrode and the second electrode to define a first fluid conduit between the first electrode and the second electrode in communication with the inlet port and the outlet port, wherein the first fluid conduit defines a tortuous path in communication with the planar faces of the first electrode and the second electrode; and control circuitry electrically coupled to the first electrode and to the second electrode, the control circuitry adapted to receive and distribute electrical power and control signals to the first electrode and to the second electrode.

The liquid heater assembly according to any of the preceding clauses, wherein the tortuous path has a serpentine configuration.

The liquid heater assembly according to any of the preceding clauses, wherein the tortuous path has a spiral configuration.

The liquid heater assembly according to any of the preceding clauses, wherein the tortuous path has an S-shaped configuration.

The liquid heater assembly according to any of the preceding clauses, wherein the heating core further includes a third electrode and a second spacer, the third electrode having planar faces, the second spacer positioned between one of the planar faces of the second electrode and one of the planar faces of the third electrode to define a second fluid conduit between the second electrode and the third electrode, the second fluid conduit defining a tortuous path and communicating with the first fluid conduit.

The liquid heater assembly according to any of the preceding clauses, wherein the planar faces of the second electrode define sides of the first flow conduit and the second flow conduit.

The liquid heater assembly according to any of the preceding clauses, wherein the width of the first spacer is different from the width of the second spacer such that the first electrode is spaced from the second electrode a distance different than the spacing between the second electrode and the third electrode.

The liquid heater assembly according to any of the preceding clauses, wherein the first fluid conduit communicates with the second fluid conduit through a cutout defined in the second electrode.

The liquid heater assembly according to any of the preceding clauses, wherein the housing has a rectangular configuration.

The liquid heater assembly according to any of the preceding clauses, wherein the housing has a cylindrical configuration.

The liquid heater assembly according to any of the preceding clauses, wherein the first spacer and the second spacer each include at least one fin, the at least one fin of the first spacer defining the configuration of the first flow conduit and the at least one fin of the second spacer defining the configuration of the second flow conduit.

The liquid heater assembly according to any of the preceding clauses, wherein the first spacer and second spacer include posts, and the first electrode, the second electrode, and the third electrode include receiver holes that mate with the posts to secure the position of the at least one fin of the first spacer and the second spacer against hydraulic forces of liquid flowing through the first and second flow conduits.

The liquid heater assembly according to any of the preceding clauses, the at least one fin of the first spacer and of the second spacer includes a plurality of fins that are positioned to define a serpentine flow path.

The liquid heater assembly according to any of the preceding clauses, wherein the at least one fin of each of the first spacer and the second spacer includes a single fin having a spiral configuration.

The liquid heater assembly according to any of the preceding clauses, wherein the tortuous path is configured to expose a liquid flowing through the first flow conduit to 50% to 75% of the surface area of the planar faces of each of the first electrode and the second electrode.

A liquid heater assembly comprising: a housing defining a cavity, the housing having an inlet port and an outlet port; a heating core received within the cavity, the heating core including a plurality of electrodes and a plurality of spacers stacked in alternating fashion within the cavity of the housing, each of the plurality of electrodes having planar faces, each spacer of the plurality of spacers positioned between confronting planar faces of adjacent electrodes of the plurality of electrodes, wherein the confronting planar faces of each of the adjacent electrodes of the plurality of electrodes and each spacer of the plurality of spacers define a fluid conduit that defines a tortuous path that communicates with the inlet port and the outlet port; and control circuitry electrically coupled to the plurality of electrodes to receive and distribute electrical power and control signals to the plurality of electrodes.

The liquid heater assembly according to any of the preceding clauses, wherein the tortuous path has a serpentine configuration.

The liquid heater assembly according to any of the preceding clauses, wherein the tortuous path has a spiral configuration.

The liquid heater assembly according to any of the preceding clauses, wherein the tortuous path is configured to expose a liquid flowing through each of the flow conduits to 50% to 75% of the surface area of the planar faces of each of the electrodes of the plurality of electrodes exposed to the liquid.

An ohmic liquid heater, comprising: a plurality of planar electrodes spaced apart along a stacking dimension, the plurality of electrodes including a first electrode and a second electrode adjacent to one another with a space defined between opposing planar faces of each of the first and second electrodes; and a structure defining a liquid flow channel passing through the space between the first and second electrodes, the structure being configured such that, when a liquid is flowing through the liquid flow channel along a flow direction, the liquid makes contact with the faces of the first and second electrodes; wherein the liquid flow channel defined by the structure follows a tortuous path along a central plane disposed between the planar faces of the first and second electrodes, the path changing directions a plurality of times within the central plane so as to define a plurality of sequential portions of the liquid flow channel along the flow direction that pass along respective portions of the first and second electrodes.

In aspects of the disclosure, the outlet temperature is at setpoint after only a single pass through the heating core 30, 150, 214 of the heater assembly 10, 100, 200.

In some aspects of the disclosure, there is little to no stagnation of the water flow, such that the velocity within a given flow conduit is uniform.

In further aspects of the disclosure, the flow throughout the heating core 30, 150, 214 containing the electrodes is primarily in turbulence or near-turbulence, which desirably further reduces the possibility of stagnation at the corners of the flow channels defining the flow conduits. The velocity profile of turbulent flow is more uniform than laminar flow, and the boundary layers of turbulent flow also beneficially tend to be thinner.

In still further aspects of the disclosure, the heating assembly 10, 100 is not vulnerable to some of the common failure modes of resistive heating elements, such as scaling, poor temperature control, or dry-fire.

Although the disclosure is directed to particular aspects of a liquid heater assembly, it is to be understood that these aspects are merely illustrative of the principles and applications of the disclosure. It is therefore to be understood that numerous modifications may be made to the illustrative aspects and that other arrangements may be devised without departing from the spirit and scope of the disclosure as defined by the appended claims.

1. A liquid heater assembly comprising:
a housing defining a cavity, the housing having an inlet port and an outlet port;
a heating core received within the cavity and including a first electrode, a second electrode, and a first spacer formed of a dielectric material positioned between the first electrode and the second electrode, each of first electrode and the second electrode having planar faces, the first spacer positioned between and engaged with the planar faces of the first electrode and the second electrode to define a first fluid conduit between the first electrode and the second electrode in communication with the inlet port and the outlet port, wherein the first fluid conduit defines a tortuous path in communication with the planar faces of the first electrode and the second electrode; and
control circuitry electrically coupled to the first electrode and to the second electrode, the control circuitry adapted to receive and distribute electrical power and control signals to the first electrode and to the second electrode.

2. The liquid heater assembly of claim 1, wherein the tortuous path has a serpentine configuration.

3. The liquid heater assembly of claim 1, wherein the tortuous path has a spiral configuration.

4. The liquid heater assembly of claim 1, wherein the tortuous path has an S-shaped configuration.

5. The liquid heater assembly of claim 1, wherein the heating core further includes a third electrode and a second spacer, the third electrode having planar faces, the second spacer positioned between one of the planar faces of the second electrode and one of the planar faces of the third electrode to define a second fluid conduit between the second electrode and the third electrode, the second fluid conduit defining a tortuous path and communicating with the first fluid conduit.

6. The liquid heater assembly of claim 5, wherein the planar faces of the second electrode define sides of the first flow conduit and the second flow conduit.

7. The liquid heater assembly of claim 5, wherein the width of the first spacer is different from the width of the second spacer such that the first electrode is spaced from the second electrode a distance different than the spacing between the second electrode and the third electrode.

8. The liquid heater assembly of claim 5, wherein the first fluid conduit communicates with the second fluid conduit through a cutout defined in the second electrode.

9. The liquid heater assembly of claim 2, wherein the housing has a rectangular configuration.

10. The liquid heater assembly of claim 2, wherein the housing has a cylindrical configuration.

11. The liquid heater assembly of claim 4, wherein the first spacer and the second spacer each include at least one fin, the at least one fin of the first spacer defining the configuration of the first flow conduit and the at least one fin of the second spacer defining the configuration of the second flow conduit.

12. The liquid heater assembly of claim 11, wherein the first spacer and second spacer include posts, and the first electrode, the second electrode, and the third electrode include receiver holes that mate with the posts to secure the position of the at least one fin of the first spacer and the second spacer against hydraulic forces of liquid flowing through the first and second flow conduits.

13. The liquid heater assembly of claim 12, the at least one fin of the first spacer and of the second spacer includes a plurality of fins that are positioned to define a serpentine flow path.

14. The liquid heater assembly of claim 13, wherein the at least one fin of each of the first spacer and the second spacer includes a single fin having a spiral configuration.

15. The liquid heater assembly of claim 1, wherein the tortuous path is configured to expose a liquid flowing through the first flow conduit to 50% to 75% of the surface area of the planar faces of each of the first electrode and the second electrode.

16. A liquid heater assembly comprising:
a housing defining a cavity, the housing having an inlet port and an outlet port;
a heating core received within the cavity, the heating core including a plurality of electrodes and a plurality of spacers stacked in alternating fashion within the cavity of the housing, each of the plurality of electrodes having planar faces, each spacer of the plurality of spacers positioned between confronting planar faces of adjacent electrodes of the plurality of electrodes, wherein the confronting planar faces of each of the adjacent electrodes of the plurality of electrodes and each spacer of the plurality of spacers define a fluid conduit that defines a tortuous path that communicates with the inlet port and the outlet port; and
control circuitry electrically coupled to the plurality of electrodes to receive and distribute electrical power and control signals to the plurality of electrodes.

17. The liquid heater assembly of claim 16, wherein the tortuous path has a serpentine configuration.

18. The liquid heater assembly of claim 16, wherein the tortuous path has a spiral configuration.

19. The liquid heater assembly of claim 16, wherein the tortuous path is configured to expose a liquid flowing through each of the flow conduits to 50% to 75% of the surface area of the planar faces of each of the electrodes of the plurality of electrodes exposed to the liquid.

20. An ohmic liquid heater, comprising:
a plurality of planar electrodes spaced apart along a stacking dimension, the plurality of electrodes including a first electrode and a second electrode adjacent to one another with a space defined between opposing planar faces of each of the first and second electrodes; and
a structure defining a liquid flow channel passing through the space between the first and second electrodes, the structure being configured such that, when a liquid is flowing through the liquid flow channel along a flow direction, the liquid makes contact with the faces of the first and second electrodes;
wherein the liquid flow channel defined by the structure follows a tortuous path along a central plane disposed between the planar faces of the first and second electrodes, the path changing directions a plurality of times within the central plane so as to define a plurality of sequential portions of the liquid flow channel along the flow direction that pass along respective portions of the first and second electrodes.
